(19) United States
(12) Patent Application Publication
(10) Pub. No.: US 2025/0219773 A1
(43) Pub. Date: Jul. 3, 2025

(54) DATA AND ENERGY PARTIAL SYMBOL DESIGN

(71) Applicant: QUALCOMM Incorporated, San Diego, CA (US)

(72) Inventors: Ahmed ELSHAFIE, San Diego, CA (US); Wei YANG, San Diego, CA (US); Seyedkianoush HOSSEINI, San Diego, CA (US); Yuchul KIM, San Diego, CA (US); Zhikun WU, Beijing (CN)

(21) Appl. No.: 18/848,664

(22) PCT Filed: Jun. 7, 2022
(86) PCT No.: PCT/CN2022/097293

§ 371 Date: Sep. 19, 2024

(51) Int. Cl. H04L 5/00; H02J 50/00; H02J 50/20; H04L 27/26; H04W 52/02

(52) U.S. Cl. CPC H04L 5/0016; H02J 50/001; H02J 50/20; H04L 27/2602; H04L 27/26522; H04W 52/0235

(57) ABSTRACT

Certain aspects of the present disclosure provide techniques for wireless communication. In one aspect, a method of wireless communication by a user equipment includes receiving a signal comprising an orthogonal frequency-division multiplexing (OFDM) symbol; harvesting energy from the signal during a first time portion of the OFDM symbol; and processing data from the symbol during a second time portion of the OFDM symbol.

### BACKGROUND

### Field of the Disclosure

Aspects of the present disclosure relate to wireless communications, and more particularly, to techniques for configuring and using data and energy partial symbol designs.

### Description of Related Art

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available wireless communication system resources with those users

Although wireless communication systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communication systems, increasing the ability for different types of devices to intercommunicate, increasing the number and type of wireless communication mediums available for use, and the like. Consequently, there exists a need for further improvements in wireless communications systems to overcome the aforementioned technical challenges and others.

### SUMMARY

One aspect provides a method of wireless communications by a user equipment. The method includes receiving a signal comprising an orthogonal frequency-division multiplexing (OFDM) symbol; harvesting energy from the signal during a first time portion of the OFDM symbol; and processing data from the symbol during a second time portion of the OFDM symbol.

Another aspect provides a method of wireless communications by a network entity. The method includes sending, to a user equipment, a signal comprising an OFDM symbol, wherein a first time portion of the OFDM symbol is configured for energy harvesting by the user equipment, and a second time portion of the OFDM symbol is configured for data by the user equipment.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communication network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communication network.

FIG. 5A depicts an example of a divided OFDM symbol comprising sub-symbols.

FIG. 5B depicts an example of a simple switching circuit that may be used by a backscatter device.

FIGS. 6A and 6B depict example of different OFDM symbols that are divided into sub-symbols based on different frequency comb structures.

FIG. 7A depicts an example of a conventional OFDM symbol.

FIG. 7B depicts an example of a divided OFDM symbol, including an energy sub-symbol and a data sub-symbol.

FIG. 8A depicts an example of configuring sub-symbols with different TCI data.

FIG. 8B depicts an example scenario in which multiple transmitting devices send power signals to a backscatter device.

FIG. 9 depicts a method for wireless communications.

FIG. 10 depicts a method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for configuring and using data and energy partial symbol designs.

Conventional design constraints for wireless devices are energy storage capability and energy (or power) use. For example, increased features and performance often come at the cost of increased energy use, and thus decreased device operating time between charging cycles. As the desire to utilize wireless devices in more applications grows, such as for long-term wireless sensing applications, these conventional design issues grow more acute.

A new generation of wireless devices may overcome conventional limitations of on-board energy storage by harvesting, and in some cases storing, energy from wireless signals (e.g., radio frequency (RF) signals) to perform wireless communications. Such energy harvesting devices (e.g., user equipments) may include, for example, radio-frequency identification (RFID) devices (e.g., RFID tags), internet of things (IoT) devices, and backscatter devices that are capable of receiving signals and “backscattering” them to another receiving device to perform wireless communications. These aforementioned devices may generally be passive, in which case they include no on-board energy storage and rely entirely on harvested energy from received signals to perform wireless communications (e.g., via backscattering signals), or they may be semi-passive and include on-board energy storage to supplement their ability to harvest energy from received signals. In some aspects, in addition to harvesting power from RF sources, energy harvesting devices may accumulate energy from other direct energy sources, such as solar energy, in order to supplement its power demands. Semi-passive energy harvesting devices may in some cases include power consuming RF components, such as analog to digital converters (ADCs), mixers, and oscillators.

Thus, energy harvesting devices are a type of user equipment that provides a low-cost and low-power solutions for many applications in a wireless communications system. Such devices may be very power efficient, sometimes requiring less than 0.1 mW of power to operate. Further, their relatively simple architectures and, in some cases, lack of battery, mean that such devices can be small, lightweight, and easily installed or integrated in many types of environments or host devices. Generally speaking then, energy harvesting devices provide practical and necessary solutions to many networking applications that require, low-cost, small footprint, durable, maintenance-free, and long lifespan communications devices. For example, energy harvesting devices may be configured as long endurance industrial sensors, which mitigates the problems of replacing batteries in and around dangerous machinery.

Emerging wireless communication network standards (e.g., 5G and/or 6G) may support energy harvesting devices (e.g., backscatter devices) for expanded applications to reduce cost and to reduce environmental impact, such as by reducing size, raw materials, and power used by networked devices.

Conventionally, energy harvesting devices are allocated a low number of resources, such as a low number of resource blocks, or even as little as one symbol. On the downlink, a small resource allocation will reduce the processing power needed by the energy harvesting device, and for the uplink, this will lower the peak-to-average-power ratio (PAPR) and transmit power required for transmission by the energy harvesting device. However, passive and semi-passive energy harvesting devices may need harvested energy to start decoding or sending data. An energy harveesting device may use a simple switching circuit where it harvests energy for some period of time and then “switches” to use it for performing wireless communications. Conventionally, such switching may be done on a relatively macro time scale for wireless communications, such as switching once per slot, or even once per symbol. Even at these switching time scales, significant latency may be introduced into wireless communications.

Accordingly, aspects described herein relate to splitting single symbols (e.g., OFDM symbols) into energy harvesting portions and data processing portions (e.g., for decoding and transmitting data). By splitting symbols in the time domain into sub-symbols, an energy harvesting device (e.g., a backscatter device) may be able to perform energy harvesting and data processing within a single symbol's timeframe, which beneficially reduces, for example, decoding and transmission delays and improves wireless communications latency. Further, network resources may be saved because fewer resources may need to be allocated to an energy harvesting device when the energy harvesting device can use a sub-divided single resource (e.g., an OFDM symbol) to perform both energy harvesting and data processing.

Aspects described herein may be particularly useful for devices having no or very limited on-board energy storage because such devices lack the ability to store significant energy reserves, even if harvesting for a long period of time.

### Introduction to Wireless Communication Networks

The techniques and methods described herein may be used for various wireless communications networks. While aspects may be described herein using terminology commonly associated with 3G, 4G, and/or 5G wireless technologies, aspects of the present disclosure may likewise be applicable to other communication systems and standards not explicitly mentioned herein.

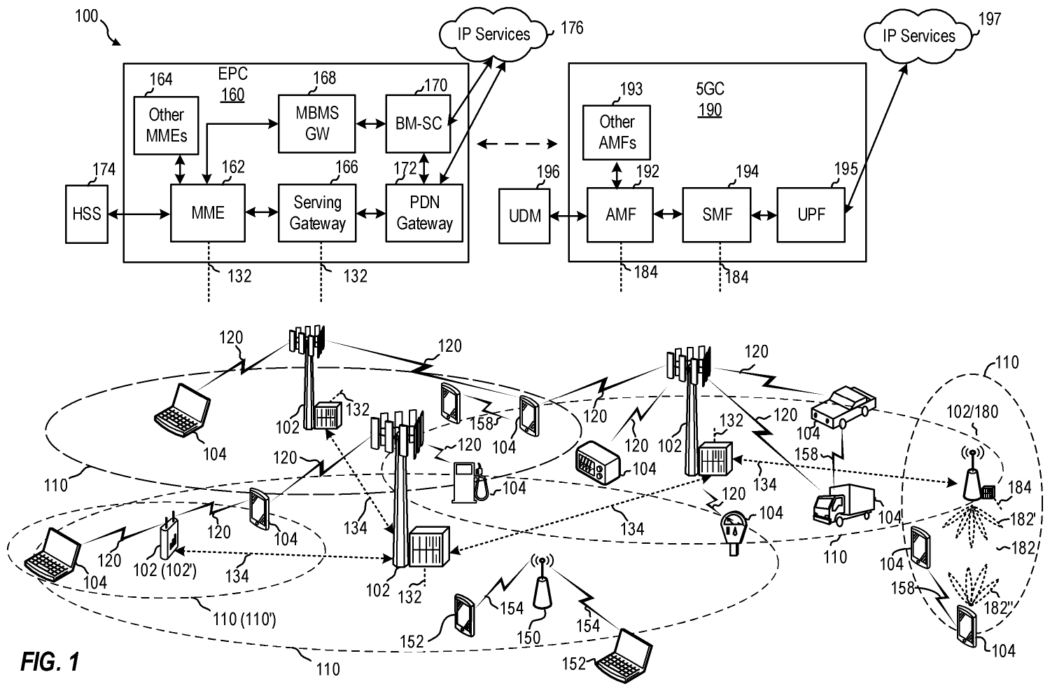

FIG. 1 depicts an example of a wireless communication network 100, in which aspects described herein may be implemented.

Generally, wireless communication network 100 includes various network entities (alternatively, network elements or network nodes). A network entity is generally a communications device and/or a communication function performed by a communications device. For example, various functions of a network as well as various devices associated with and interacting with a network may be considered network entities.

In the depicted example, wireless communication network 100 includes base stations (BSs) 102, user equipments (UEs) 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with UEs 104 via communications links 120. The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and others. Each of BSs 102 may provide communication coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communication coverage for a macro cell (covering relatively large geographic area), a pico cell (covering relatively smaller geographic area, such as a sports stadium), a femto cell (relatively smaller geographic area (e.g., a home)), and/or other types of cells.

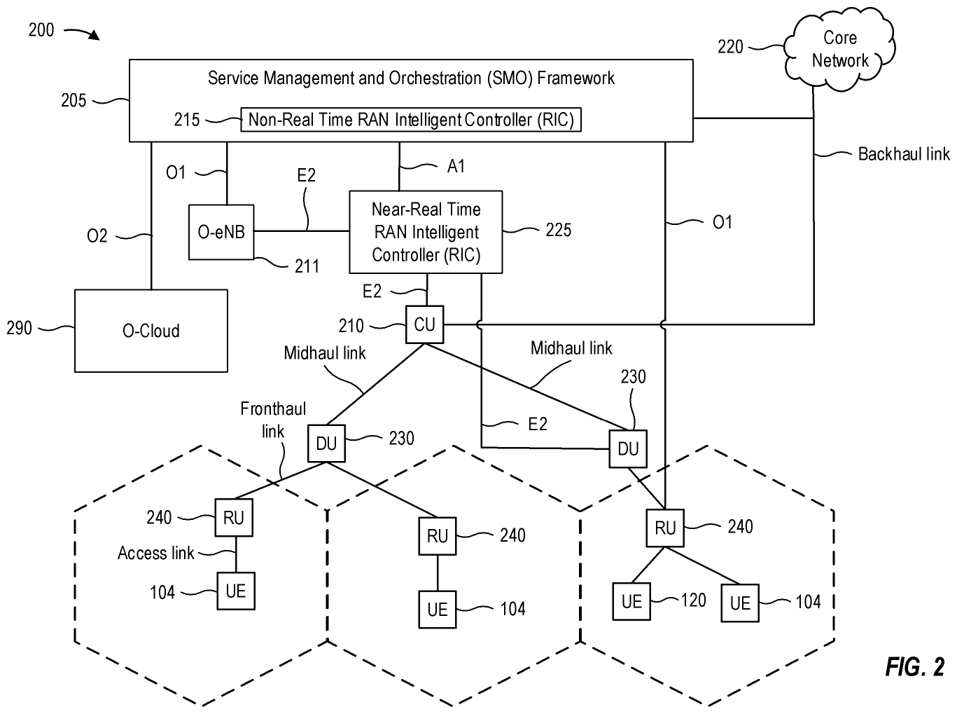

While BSs 102 are depicted in various aspects as unitary communications devices, BSs 102 may be implemented in various configurations. For example, one or more components of base station may be disaggregated, including a central unit (CU), one or more distributed units (DUs), one or more radio units (RUs), a radio unit (RU), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communication network 100 may also be configured to support different radio access technologies, such as 3G, 4G, and 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communication network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communication links 120 between BSs 102 and, for example, UEs 104, may be through one or more carriers, which may have different bandwidths (e.g., 5, 10, 15, 20, 100, 400, and other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. BS 180 may also receive the beamformed signal from UE 104 in one or more receive directions 182′. Base station 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communication network 100 further includes a Wi-Fi AP 150 in communication with Wi-Fi stations (STAs) 152 via communication links 154 in, for example, a 2.4 GHz and/or 5 GHz unlicensed frequency spectrum.

Certain UEs 104 may communicate with each other using device-to-device (D2D) communication link 158. D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172 in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

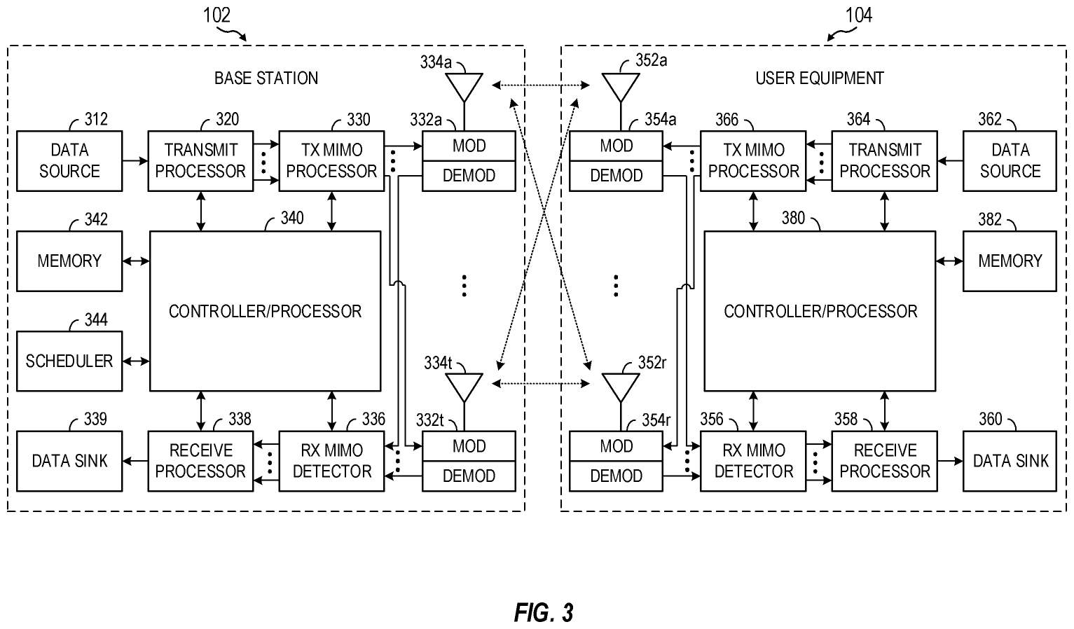

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., data source 362) and wireless reception of data (e.g., data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and other aspects described herein.

In some aspects, a processor may be configured to perform various operations, such as those associated with the methods described herein, and transmit (output) to or receive (obtain) data from another interface that is configured to transmit or receive, respectively, the data.

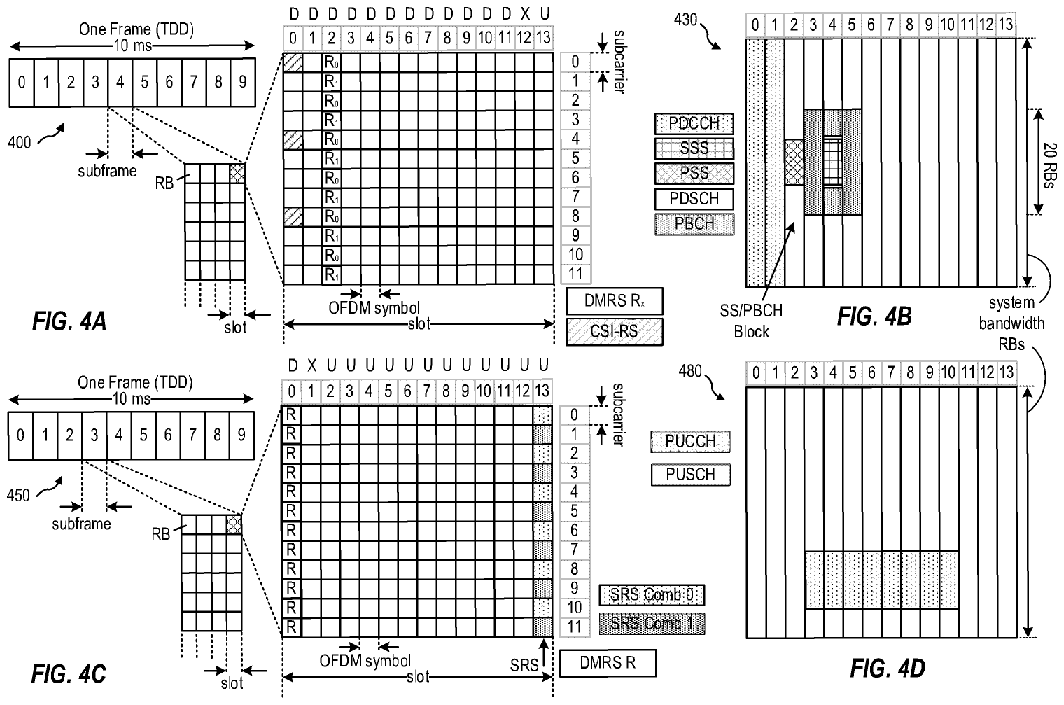

FIGS. 4A, 4B, 4C, and 4D depict aspects of data structures for a wireless communication network, such as wireless communication network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communication systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and in the time domain with SC-FDM.

A wireless communication frame structure may be frequency division duplex (FDD), in which for a particular set of subcarriers and subframes within the set of subcarriers are dedicated for either DL or UL. Wireless communication frame structures may also be time division duplex (TDD), in which for a particular set of subcarriers and subframes within the set of subcarriers are dedicated for both DL and UL.

In FIG. 4A and 4C, the wireless communication frame structure is TDD where D is DL, U is UL, and X is flexible for use between DL/UL. UEs may be configured with the slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot configuration. Subframes may also include mini-slots, which generally have fewer symbols than an entire slot. Other wireless communication technologies may have a different frame structure and/or different channels.

Generally, the number of slots within a subframe is based on a slot configuration and a numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 24×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and CSI-RS for channel estimation at the UE. The RS may also include beam measurement RS (BRS), beam refinement RS (BRRS), and phase tracking RS (PT-RS).

FIG. 4B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may also transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Data and Energy Partial Symbol Design

As above, aspects described herein relate to splitting single symbols (e.g., OFDM symbols) into energy harvesting portions and data processing portions, which beneficially reduces, for example, decoding and transmission delays and improves wireless communications latency. Generally, aspects described herein are applicable to communications between a network entity and a user equipment (e.g., on a Uu interface) as well as between user equipments (e.g., on a sidelink/PC5 interface). Further, as described further herein, an RF source for providing energy during portions of split symbols may generally be a network entity, such as a base station, or a user equipment.

Decoding symbols generally involves using a signal transformation process, such as a discrete Fourier transform (DFT) or a fast Fourier transform (FFT). Due to special properties of DFT and FFT, a frequency domain comb structure used for transmitting a symbol creates time-domain repetitions (FIG. 4C depicts examples of frequency comb structures used for transmitting resources). For example, a comb-2 structure in the frequency domain means that every other tone is set to zero and the signals may be [x, x] and [y, −y], depending on whether the signal is transmitted on odd or even subcarriers. More generally, a comb-K structure in frequency will create K repetitions in the time domain. Note that the comb-level (e.g., comb-2, comb-4, comb-K) is a configurable parameter for a user equipment. For example, the comb-level may be configured by a network entity by RRC signaling, medium access control-control element (MAC-CE), or DCI, or by a user equipment (e.g., for sidelink communications) using sidelink control information (SCI), MAC-CE, or RRC signaling. Thus the number of repetitions in the time domain of a signal based on its frequency comb-level is configurable.

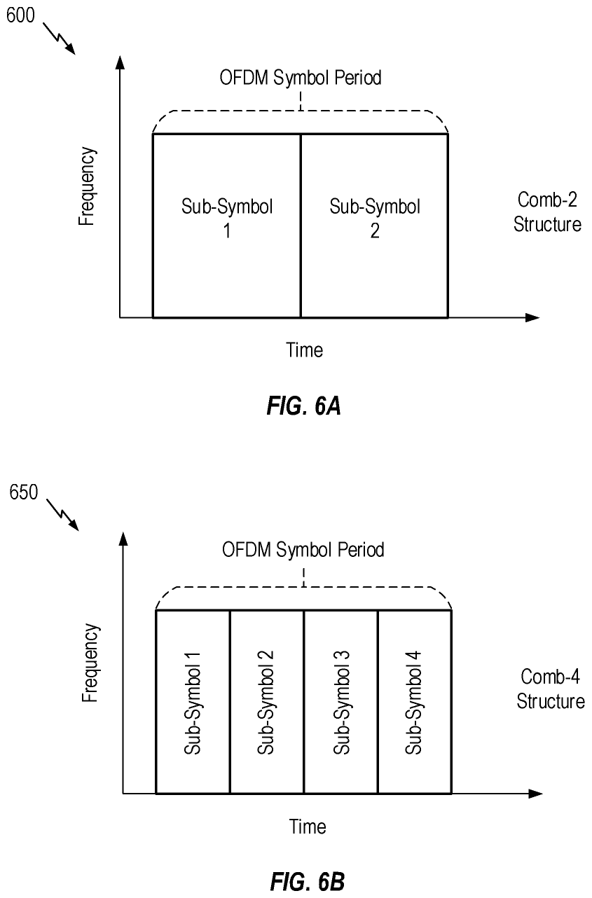

Aspects described herein leverage the special properties of DFT and FFT to support partial-symbol energy harvesting and data processing, including decoding and transmission. For example, if an OFDM symbol of energy/data are constrained to only occupy half of the tones in the frequency using a comb-2 frequency structure, the OFDM symbol will have a repetition structure in the time domain, where the second half OFDM symbol is a repetition of the first half of the OFDM symbol. In such an example, a backscatter device receiving the OFDM symbol may use the first half symbol as an energy signal to power the device and the second half symbol as a data signal. As above, because the idea generalizes to more than two repetitions with, for example, a comb-K structure where K>2, a backscatter device can beneficially be configured to harvest energy during a configurable amount of time during a single OFDM symbol, e.g., using a configurable number of repetitions, and then start to decode or transmit using some or all of the remaining amount of time (and repetitions) in the single OFDM symbol. Thus, for example, a comb-2 structure will generate two repetitions in the time domain, and the first repetition (e.g., the first half of an OFDM symbol) may be used for energy harvesting and the second repetition (e.g., second half of the OFDM symbol) can be used for data, or vice versa. As the comb-level increases, leading to more repetitions, more patterns can be configured, as described in more detail below with respect to FIGS. 6A and 6B. In some aspects, the comb-level (e.g., comb-K) may determine the length of time of a repetition and/or sub-symbol. So, for example, where K=4, the sub-symbol may be divided into 4 sub-symbols each taking ¼ of the total symbol time.

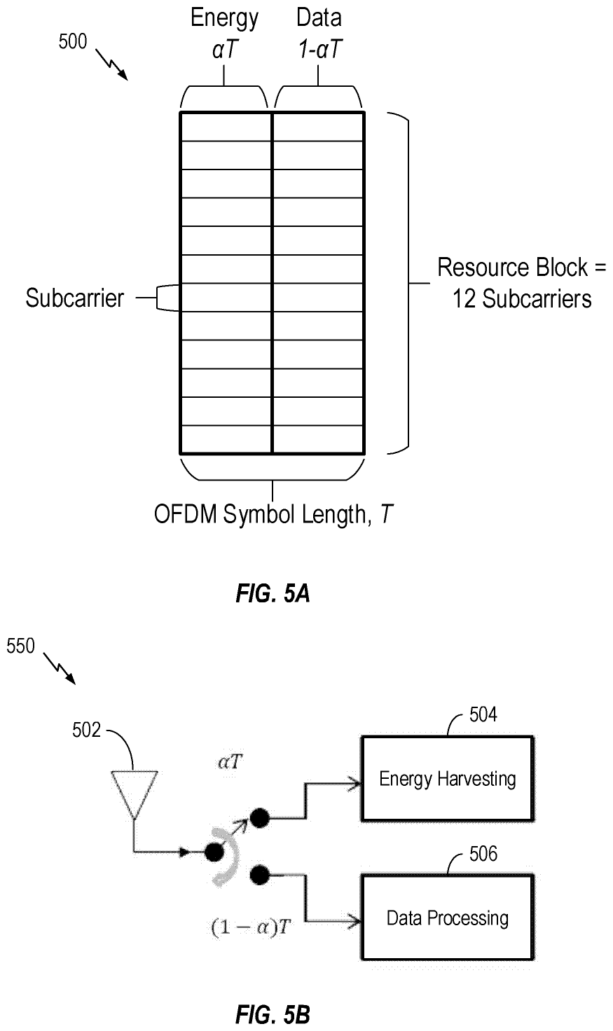

FIG. 5A depicts an example of a divided (or partitioned) OFDM symbol 500 comprising sub-symbols. In the depicted example, OFDM symbol 500 is of time length T, of which a first time portion of the symbol, αT, is configured for energy harvesting, and a second time portion of the symbol, 1−αT, is configured for data processing. The first time portion and the second time portion of symbol 500 may be referred to as sub-symbols of symbol 500. Consider the example of a passive IoT device with no battery, the energy harvesting portion of symbol 500 may be used to charge up a capacitor (or super capacitor) to perform data processing during the data portion of the symbol.

In the depicted example, the symbol includes a resource block of 12 subcarriers, though in other implementations, a different configuration may be used. Note that while OFDM symbol 500 is shown as divided into two sub-symbols, as described further in other examples, other configurations are possible.

FIG. 5B depicts an example of a simple switching circuit 550 that may be used by an energy harvesting device (e.g., a user equipment, such as a backscattering user equipment, RFID tag, or the like) to switch between an energy harvesting mode 504 (e.g., in which RF signals received via antenna 502 are used for harvesting energy) and a data processing mode 506 in which received data may be decoded and/or backscattered (e.g., transmitted to another device).

FIG. 5A may be an example of partitioning an OFDM symbol into two portions when a comb-2 structure is used in the frequency domain. However, as above, the general idea of subdividing OFDM symbols can be extended to cover symbol partitions of size 1/K, where K is any integer greater than or equal to 2.

In some aspects, K might be configured as an integer that is an even divisor to a number of subcarriers in a resource block associated with a symbol that is being subdivided. For example, whereas in FIG. 5A there are 12 subcarriers, K might be preferably set to 3, 4, 6, or 12, since each of these integers are evenly dividable by 12.

More generally, then length of an energy portion of a symbol (in the time domain) can be described as m/K, where m ∈ {1,2, . . . , K−1}; that is, the energy portion can generally have any time length between 1/K OFDM symbols to (K−1)/K OFDM symbols.

FIGS. 6A and 6B depict example of two different OFDM symbols that are divided into two and four sub-symbols, respectively, based on comb-2 and comb-4 frequency domain structures, respectively.

Specifically, in example 600 of FIG. 6A, each of sub-symbols 1 and 2 are length 1/K, where K=2 in this example. Thus, each of sub-symbols 1 and 2 take up one-half of the symbol size in the time domain. In example 650 of FIG. 6B, each of sub-symbols 1-4 are length 1/K, where K=4 in Note that these are just two examples, and many others are possible.

In the examples of FIGS. 6A and 6B, any of the individual sub-symbols may be configured for energy harvesting or for data, including for uplink or downlink. Thus, sub-symbol patterns may be used, such as, for example: (DL| . . . |UL), (energy| . . . |DL), (energy| . . . |UL), (DL|DL| . . . |DL), and others.

In some aspects, a transmitting device (e.g., a base station or other network entity or a user equipment performing sidelink communications) that knows a state of charge (e.g., a state of charge of an on-board battery or other energy store) of a backscatter device may switch between sub-symbol patterns based on the state of charge. Consider one example in which a comb-2 structure is used and the OFDM symbol includes two sub-symbols, as in FIG. 6A, the transmitting device may switch between an (energy|data) pattern and a (data|data) sub-symbol pattern. More generally, the transmitting device may select a pattern that either increases or decreases the relative amount of the energy portion of the OFDM symbol based on the state of charge to help the backscatter device maintain a threshold level of power, or to prepare the backscatter device for a power-intensive operation.

In some aspects, when a higher comb-level is used, then a first set of sub-symbols in a symbol are used for energy and a second set of sub-symbols in the symbol are used for data. The size of the first set can be as small as zero. In some aspects, a start and length indicator (SLIV) can be used to indicate energy vs data sizes. In other aspects, a bitmap may be used.

In some aspects, the comb-level of data is determined based on the state of charge (e.g., battery level) of the backscatter device.

Further, individual sub-symbols may be configured for time domain repetition. For example, if sub-symbols 3 and 4 in example 650 are both data symbols, they may be a repetition of the same data, or represent different data in each sub-symbol.

Further yet, the individual sub-symbols may be multiplexed among different user equipments. For example, using orthogonal cover codes, sub-symbol 1 in example 600 could be configured for a first user equipment while sub-symbol 2 in that example could be configured for a second user equipment. This beneficially allows for sending multiple data streams even within a single symbol's time allocation in the time domain.

In some cases, more than one user equipment may be orthogonally multiplexed on the same OFDM sub-symbol (e.g., any of the sub-symbols of FIGS. 6A and 6B). This may be accomplished in one example by assigning the different user equipments with different time-domain orthogonal cover codes. In such a case, the time domain orthogonal cover code are multiplied to the time domain repetitions, which as above are each of length 1/K of an OFDM symbol.

For example, a time domain orthogonal cover code [1,1,1,1] creates a comb-4 frequency domain signal that only occupies the first tone of every four tones. As another example, the time domain orthogonal cover code [1,−1,−1,1] creates a comb-2 frequency domain signal that occupies the second and fourth tone of every four tones. Two different user equipments that use the orthogonal cover codes [1,1,1,1] and [1,−1,−1,1], respectively, have signals that are orthogonal to each other.

In various aspects, length-K orthogonal cover codes are configured to have the same value in the first and last position, e.g., [1, x, . . . , x, 1], in order to preserve the cyclic prefix structure. This is because the end of the first repetition must be equal to the cyclic prefix, which is taken from the end of the last repetition, and thus the first repetition and last repetition should be equal, which maintains orthogonality of the user equipments' signals after removing the first 1/K portion of the multiplexed OFDM symbol.

### Adapting Cyclic Prefixes for Data and Energy Apportioned Symbols

In various aspects described herein, an energy harvesting portion of a divided (or partitioned) symbol may be dedicated to energy harvesting and therefore may use different waveforms and may not carry any repetition of data. A dedicated energy signal for the energy harvesting portion of the symbol generally does not need a cyclic prefix, so a cyclic prefix may instead be added to a data portion of the divided symbol.

However, the data portion of a divided symbol, e.g., the data sub-symbol, is shorter in time than a normal symbol, so a new cyclic prefix size (e.g., time) may be used for the data portion of the divided symbol. In some aspects, the new cyclic prefix may be a downsampled conventional cyclic prefix, which is to say it may be a smaller size (e.g., shorter in time) cyclic prefix. For example, the downsampled cyclic prefix could be half the size as a cyclic prefix for a full symbol in the case of a comb-2 frequency structure, and similarly could be one-quarter the size in the case of a comb-4 frequency structure. More generally, the downsampled cyclic prefix can be configurable based on the comb structure used and/or based on channel characteristics, such as the delay spread. Note that generally that cyclic prefix length for a data sub-symbol should be greater than the delay spread to avoid inter-OFDM-block interference.

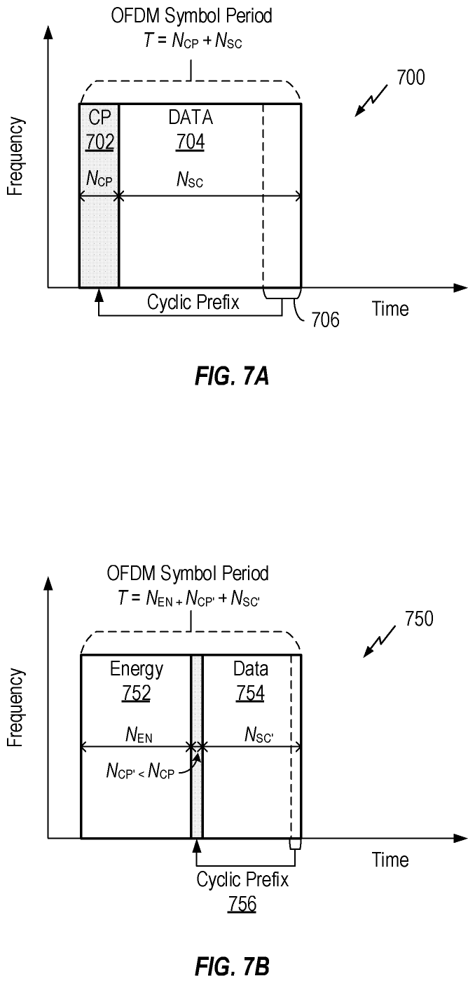

FIG. 7A depicts an example of a conventional OFDM symbol 700 that includes a data portion 704 of length N_{sc} and a cyclic prefix (CP) portion 702 of length N_{cp} that is based on an end portion 706 of the data portion 704. As depicted, the total size of the symbol 700 in the time domain is T=N_{CP}+N_{SC}.

FIG. 7B depicts an example of a divided OFDM symbol 750, including an energy sub-symbol 752 and a data sub-symbol 754. As discussed above, because the energy sub-symbol may be a dedicated portion, it needs no cyclic prefix. Accordingly, the data sub-symbol includes a downsampled cyclic prefix 756 of length N_{CP}′, which is shorter than the cyclic prefix length, N_{CP}, for the conventional symbol 700 in FIG. 7A. Similarly, the data portion has a length of N_{SC}′, which is shorter than the length of the data portion 704 in symbol 700 of FIG. 7A. This is because symbol 750 includes a portion of size N_{EN} in the time domain that is dedicated to energy. Thus, in the depicted example, the total size of the symbol 750 in the time domain is T=N_{EN}+N_{CP}′+N_{SC}.

### Transmission Configuration Indicators for Sub-Symbols

When allocating different sub-symbols within an OFDM symbol to different purposes, it is possible configure each of the sub-symbols with different transmission configuration indicator (TCI) states.

For example, an RF source device (e.g., a base station or other user equipment) may increase transmission power for an energy sub-symbol relative to a data sub-symbol. More generally, the power level for each sub-symbol may be independently configured, such as by the RF source device. In one aspect, the RF source device may configure the sub-symbols with different TCI states that indicate different transmission power levels.

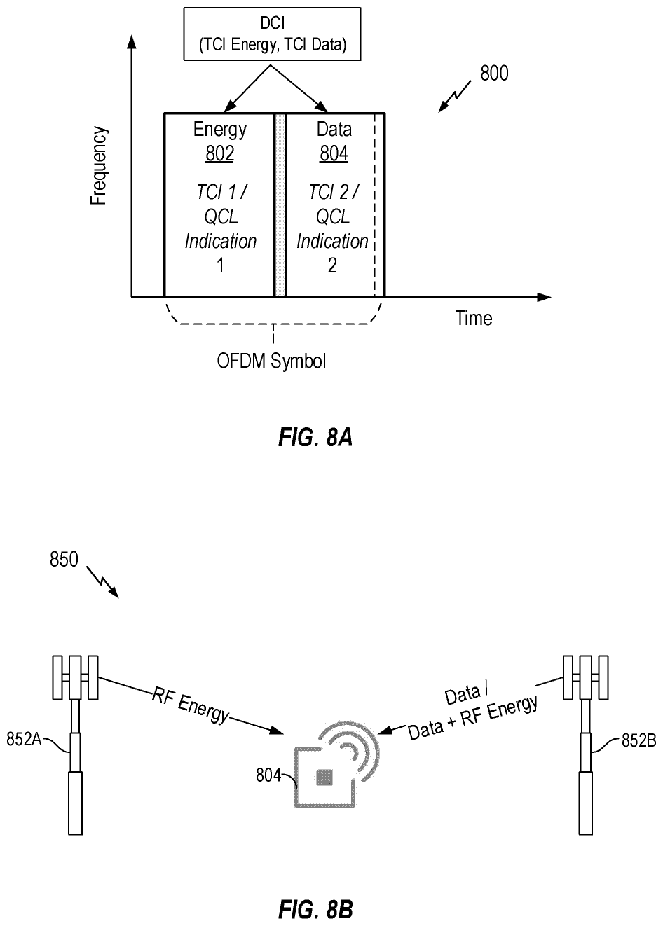

FIG. 8A depicts an example of configuring sub-symbols with different TCI data. In FIG. 8A, energy sub-symbol 802 of symbol 800 is configured with a first TCI and data sub-symbol 804 is configured with a second TCI. In some aspects, the TCI for the energy sub-symbol and the TCI for the data sub-symbol may be communicated to the backscatter device via downlink control information (DCI).

Configuring different sub-symbols with different TCI information also allows for configuring different sub-symbols with different quasi-collocation (QCL) indications when multiple devices are transmitting to a single backscatter device.

For example, FIG. 8B depicts an example scenario 850 in which multiple transmitting devices send power signals to a backscatter device. In particular, a first transmitting device 852A is transmitting RF energy to backscatter device 854. Simultaneously, a second transmitting device 852B may be transmitting RF energy and/or data to backscatter device 854. Thus, the first and second transmitting device may collaborate to provide sufficient RF-based power to backscatter device 854.

To do so effectively, one of the transmitting devices may configure backscatter device 854 with a QCL indication for the RF energy signal and another QCL indication for the data signal, such as depicted in FIG. 8A. In some aspects, the energy sub-symbol may use a QCL type D (filter). With such indications, backscatter device 854 can use the same antenna panel or different antenna panels when receiving the RF energy and data (or data+RF energy) signals from transmitting devices 852A and 852B.

When a network allocates more than one device to send energy signals to a backscatter device, as in the example of FIG. 8B, the network can configure each RF energy source (e.g., small cell, UE, dedicated energy cell, etc.) to use a certain transmission filter and precoding matrix indicator (PMI) for the energy signal transmission. In some aspects, the network can inform each RF energy source (e.g., 852A and 852B) to use a certain filter associated with a previous SRS, CSI-RS, or synchronization signal block (SSB) to transmit the energy signal using a particular TCI state, which may include QCL info.

### Example Operations of a User Equipment

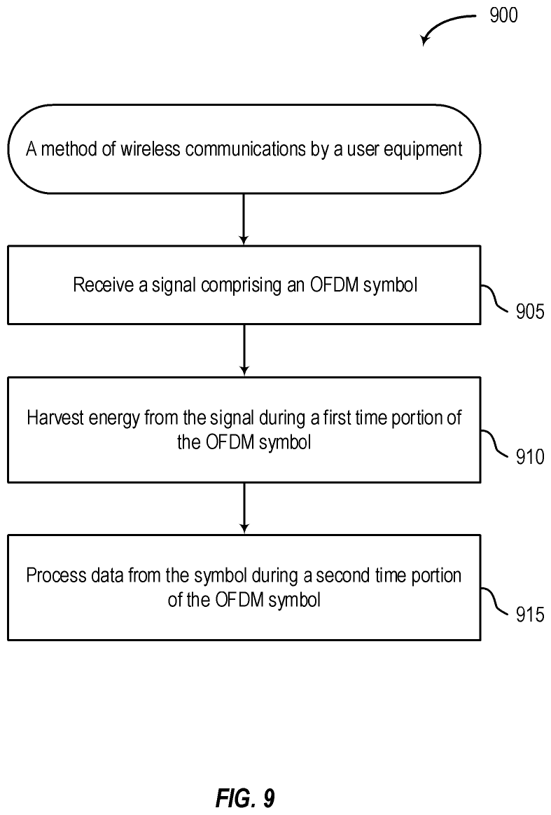

FIG. 9 shows an example of a method 900 for wireless communications by a UE, such as UE 104 of FIGS. 1 and 3. In some aspects, the UE is a backscatter device, such as a passive or semi-passive backscatter device.

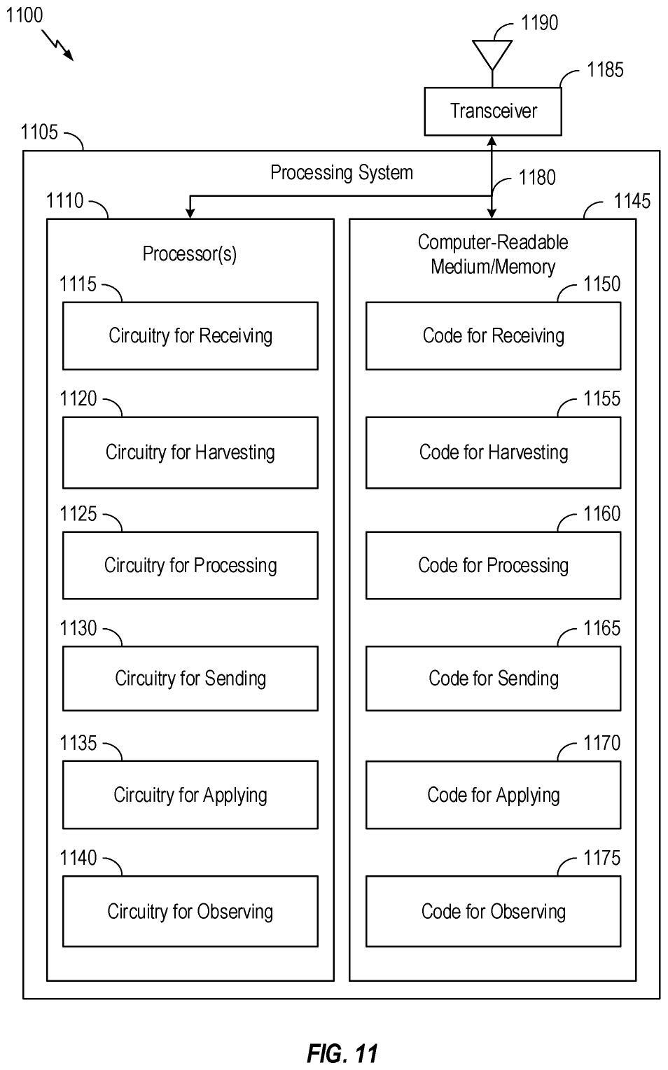

Method 900 begins at step 905 with receiving a signal comprising an OFDM symbol. In some cases, the operations of this step refer to, or may be performed by, circuitry for receiving and/or code for receiving as described with reference to FIG. 11.

Method 900 then proceeds to step 910 with harvesting energy from the signal during a first time portion of the OFDM symbol. In some cases, the operations of this step refer to, or may be performed by, circuitry for harvesting and/or code for harvesting as described with reference to FIG. 11.

Method 900 then proceeds to step 915 with processing data from the symbol during a second time portion of the OFDM symbol. In some cases, the operations of this step refer to, or may be performed by, circuitry for processing and/or code for processing as described with reference to FIG. 11.

In some aspects, processing data from the symbol comprises decoding data and storing the decoded data in a memory of the user equipment.

In some aspects, processing data from the symbol comprises backscattering data from the OFDM.

In some aspects, processing data from the symbol is performed using, at least in part, the energy harvested from the signal.

In some aspects, the second time portion comprises a number of frequency portions based on a frequency comb configuration for the OFDM symbol.

In some aspects, a length of the first time portion and a length of the second time portion of the OFDM symbol is based on the frequency comb configuration for the OFDM symbol.

In some aspects, the number of frequency portions is evenly divisible with a number of subcarriers in the OFDM symbol.

In some aspects, the number of subcarriers in the signal is 12.

In some aspects, the method 900 further includes receiving an indication of an orthogonal cover code to apply to the OFDM symbol from a network entity. In some cases, the operations of this step refer to, or may be performed by, circuitry for receiving and/or code for receiving as described with reference to FIG. 11.

In some aspects, the method 900 further includes applying the orthogonal cover code to the OFDM symbol to process data from the OFDM symbol. In some cases, the operations of this step refer to, or may be performed by, circuitry for applying and/or code for applying as described with reference to FIG. 11.

In some aspects, the method 900 further includes observing a cyclic prefix between the first time portion and the second time portion of the OFDM symbol. In some cases, the operations of this step refer to, or may be performed by, circuitry for observing and/or code for observing as described with reference to FIG. 11.

In some aspects, the cyclic prefix comprises a downsampled normal cyclic prefix.

In some aspects, a received energy of the signal is higher during the first time portion of the OFDM symbol than during the second time portion of the OFDM symbol.

In some aspects, receiving the signal comprising an OFDM symbol comprises receiving at least the first time portion of the OFDM symbol from a plurality of devices.

In some aspects, the method 900 further includes receiving, from a network entity, a first quasi-collocation indication associated with the first time portion of the OFDM symbol. In some cases, the operations of this step refer to, or may be performed by, circuitry for receiving, and/or code for receiving, as described with reference to FIG. 11.

In some aspects, the method 900 further includes receiving, from the network entity, a second quasi-collocation indication associated with the second time portion of the OFDM symbol. In some cases, the operations of this step refer to, or may be performed by, circuitry for receiving, and/or code for receiving, as described with reference to FIG. 11.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a Network Entity

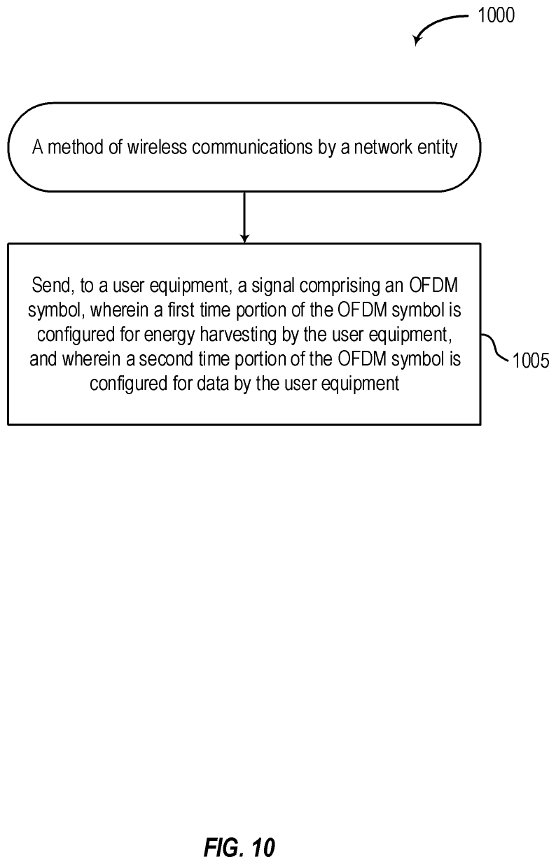

FIG. 10 shows an example of a method 1000 for wireless communications by a network entity, such as BS 102 of FIGS. 1 and 3, or a disaggregated base station as discussed with respect to FIG. 2.

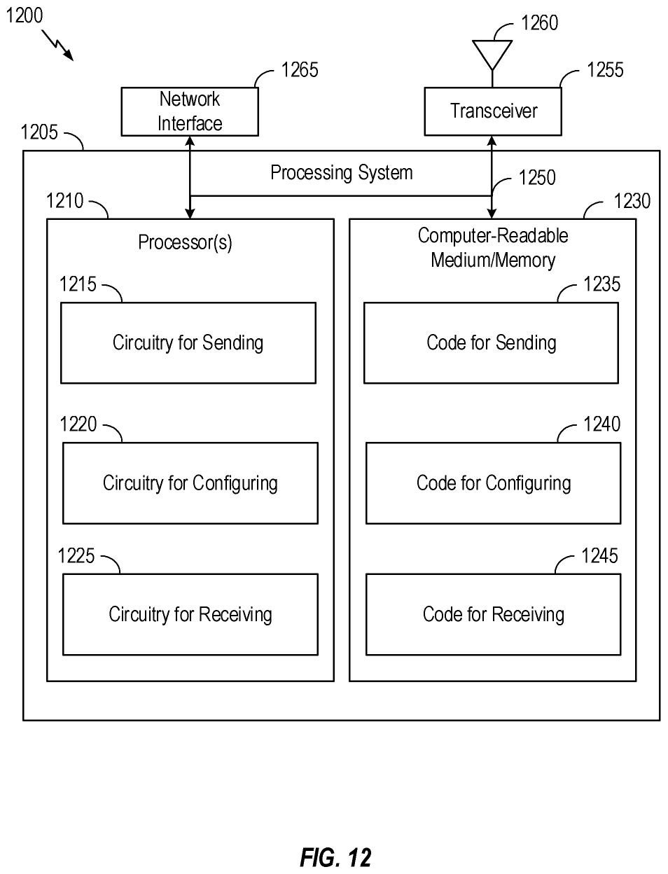

Method 1000 begins at step 1005 with sending, to a user equipment, a signal comprising an OFDM symbol, wherein a first time portion of the OFDM symbol is configured for energy harvesting by the user equipment, and a second time portion of the OFDM symbol is configured for data by the user equipment. In some cases, the operations of this step refer to, or may be performed by, circuitry for sending and/or code for sending as described with reference to FIG. 12.

In some aspects, the second time portion comprises a number of frequency portions based on a frequency comb configuration for the OFDM symbol.

In some aspects, a length of the first time portion and a length of the second time portion of the OFDM symbol is based on the frequency comb configuration for the OFDM symbol.

In some aspects, the number of frequency portions is evenly divisible with a number of subcarriers in the OFDM symbol.

In some aspects, the number of subcarriers in the signal is 12.

In some aspects, the method 1000 further includes sending, to the user equipment, an indication of an orthogonal cover code to apply to the OFDM symbol. In some cases, the operations of this step refer to, or may be performed by, circuitry for sending, and/or code for sending, as described with reference to FIG. 12.

In some aspects, the method 1000 further includes configuring a cyclic prefix between the first time portion and the second time portion of the OFDM signal. In some cases, the operations of this step refer to, or may be performed by, circuitry for configuring and/or code for configuring as described with reference to FIG. 12.

In some aspects, the cyclic prefix comprises a downsampled normal cyclic prefix.

In some aspects, the method 1000 further includes sending the first time portion of the OFDM symbol at a higher energy level than the second time portion of the OFDM symbol. In some cases, the operations of this step refer to, or may be performed by, circuitry for sending and/or code for sending as described with reference to FIG. 12.

In some aspects, the method 1000 further includes configuring a second device to send a second OFDM symbol during at least the first time portion of the OFDM symbol. In some cases, the operations of this step refer to, or may be performed by, circuitry for configuring and/or code for configuring as described with reference to FIG. 12.

In some aspects, the method 1000 further includes sending, to the user equipment, a first quasi-collocation indication associated with the first time portion of the OFDM symbol. In some cases, the operations of this step refer to, or may be performed by, circuitry for sending, and/or code for sending, as described with reference to FIG. 12.

In some aspects, the method 1000 further includes sending, to the user equipment, a second quasi-collocation indication associated with the second time portion of the OFDM symbol. In some cases, the operations of this step refer to, or may be performed by, circuitry for sending, and/or code for sending, as described with reference to FIG. 12.

In some aspects, the first quasi-collocation indication and the second quasi-collocation indication are sent via downlink control information.

In some aspects, the method 1000 further includes receiving, from the user equipment, an indication of an energy state. In some cases, the operations of this step refer to, or may be performed by, circuitry for receiving, and/or code for receiving, as described with reference to FIG. 12.

In some aspects, the method 1000 further includes configuring the first time portion of the OFDM symbol based on the indication. In some cases, the operations of this step refer to, or may be performed by, circuitry for configuring and/or code for configuring as described with reference to FIG. 12.

In some aspects, the method 1000 further includes configuring a comb setting for the OFDM symbol based on the indication of the energy state. In some cases, the operations of this step refer to, or may be performed by, circuitry for configuring and/or code for configuring as described with reference to FIG. 12.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to the transceiver 1185 (e.g., a transmitter and/or a receiver). The transceiver 1185 is configured to transmit and receive signals for the communications device 1100 via the antenna 1190, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1145 via a bus 1180. In certain aspects, the computer-readable medium/memory 1145 is configured to store instructions (e.g., computer-executable code) that when executed by the one or more processors 1110, cause the one or more processors 1110 to perform the method 900 described with respect to FIG. 9, or any aspect related to it. Note that reference to a processor performing a function of communications device 1100 may include one or more processors 1110 performing that function of communications device 1100.

In the depicted example, computer-readable medium/memory 1145 stores code (e.g., executable instructions), such as code for receiving 1150, code for harvesting 1155, code for processing 1160, code for sending 1165, code for applying 1170, and code for observing 1175. Processing of the code for receiving 1150, code for harvesting 1155, code for processing 1160, code for sending 1165, code for applying 1170, and code for observing 1175 may cause the communications device 1100 to perform the method 900 described with respect to FIG. 9, or any aspect related to it.

The one or more processors 1110 include circuitry configured to implement (e.g., execute) the code stored in the computer-readable medium/memory 1145, including circuitry such as circuitry for receiving 1115, circuitry for harvesting 1120, circuitry for processing 1125, circuitry for sending 1130, circuitry for applying 1135, and circuitry for observing 1140. Processing with circuitry for receiving 1115, circuitry for harvesting 1120, circuitry for processing 1125, circuitry for sending 1130, circuitry for applying 1135, and circuitry for observing 1140 may cause the communications device 1100 to perform the method 900 described with respect to FIG. 9, or any aspect related to it.

Various components of the communications device 1100 may provide means for performing the method 900 described with respect to FIG. 9, or any aspect related to it. For example, means for transmitting, sending or outputting for transmission may include transceivers 354 and/or antenna(s) 352 of the UE 104 illustrated in FIG. 3 and/or the transceiver 1185 and the antenna 1190 of the communications device 1100 in FIG. 11. Means for receiving or obtaining may include transceivers 354 and/or antenna(s) 352 of the UE 104 illustrated in FIG. 3 and/or the transceiver 1185 and the antenna 1190 of the communications device 1100 in FIG. 11.

FIG. 12 depicts aspects of an example communications device 1200. In some aspects, communications device 1200 is a network entity, such as BS 102 of FIGS. 1 and 3, or a disaggregated base station as discussed with respect to FIG. 2.

The communications device 1200 includes a processing system 1205 coupled to the transceiver 1255 (e.g., a transmitter and/or a receiver) and/or a network interface 1265. The transceiver 1255 is configured to transmit and receive signals for the communications device 1200 via the antenna 1260, such as the various signals as described herein. The network interface 1265 is configured to obtain and send signals for the communications device 1200 via communication link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1230 via a bus 1250. In certain aspects, the computer-readable medium/memory 1230 is configured to store instructions (e.g., computer-executable code) that when executed by the one or more processors 1210, cause the one or more processors 1210 to perform the method 1000 described with respect to FIG. 10, or any aspect related to it. Note that reference to a processor of communications device 1200 performing a function may include one or more processors 1210 of communications device 1200 performing that function.

In the depicted example, the computer-readable medium/memory 1230 stores code (e.g., executable instructions), such as code for sending 1235, code for configuring 1240, and code for receiving 1245. Processing of the code for sending 1235, code for configuring 1240, and code for receiving 1245 may cause the communications device 1200 to perform the method 1000 described with respect to FIG. 10, or any aspect related to it.

The one or more processors 1210 include circuitry configured to implement (e.g., execute) the code stored in the computer-readable medium/memory 1230, including circuitry such as circuitry for sending 1215, circuitry for configuring 1220, and circuitry for receiving 1225. Processing with circuitry for sending 1215, circuitry for configuring 1220, and circuitry for receiving 1225 may cause the communications device 1200 to perform the method 1000 as described with respect to FIG. 10, or any aspect related to it.

Various components of the communications device 1200 may provide means for performing the method 1000 as described with respect to FIG. 10, or any aspect related to it. Means for transmitting, sending or outputting for transmission may include transceivers 332 and/or antenna(s) 334 of the BS 102 illustrated in FIG. 3 and/or the transceiver 1255 and the antenna 1260 of the communications device 1200 in FIG. 12. Means for receiving or obtaining may include transceivers 332 and/or antenna(s) 334 of the BS 102 illustrated in FIG. 3 and/or the transceiver 1255 and the antenna 1260 of the communications device 1200 in FIG. 12.

### Example Clauses

Implementation examples are described in the following numbered clauses:

Clause 1: A method of wireless communication by a user equipment, comprising: receiving a signal comprising an OFDM symbol; harvesting energy from the signal during a first time portion of the OFDM symbol; and processing data from the symbol during a second time portion of the OFDM symbol.

Clause 2: The method of Clause 1, wherein processing data from the symbol comprises decoding data and storing the decoded data in a memory of the user equipment.

Clause 3: The method of any one of Clauses 1 and 2, wherein processing data from the symbol comprises backscattering data from the OFDM.

Clause 4: The method of any one of Clauses 1-3, wherein processing data from the symbol is performed using, at least in part, the energy harvested from the signal.

Clause 5: The method of any one of Clauses 1-4, wherein the second time portion comprises a number of frequency portions based on a frequency comb configuration for the OFDM symbol.

Clause 6: The method of Clause 5, wherein a length of the first time portion and a length of the second time portion of the OFDM symbol is based on the frequency comb configuration for the OFDM symbol.

Clause 7: The method of Clause 5, wherein the number of frequency portions is evenly divisible with a number of subcarriers in the OFDM symbol.

Clause 8: The method of Clause 7, wherein the number of subcarriers in the signal is 12.

Clause 9: The method of any one of Clauses 1-8, further comprising: receiving an indication of an orthogonal cover code to apply to the OFDM symbol from a network entity; and applying the orthogonal cover code to the OFDM symbol to process data from the OFDM symbol.

Clause 10: The method of any one of Clauses 1-9, further comprising: observing a cyclic prefix between the first time portion and the second time portion of the OFDM symbol.

Clause 11: The method of Clause 10, wherein the cyclic prefix comprises a downsampled normal cyclic prefix.

Clause 12: The method of any one of Clauses 1-11, wherein a received energy of the signal is higher during the first time portion of the OFDM symbol than during the second time portion of the OFDM symbol.

Clause 13: The method of any one of Clauses 1-12, wherein receiving the signal comprising an OFDM symbol comprises receiving at least the first time portion of the OFDM symbol from a plurality of devices.

Clause 14: The method of any one of Clauses 1-13, further comprising: receiving, from a network entity, a first quasi-collocation indication associated with the first time portion of the OFDM symbol; and receiving, from the network entity, a second quasi-collocation indication associated with the second time portion of the OFDM symbol.

Clause 15: A method of wireless communication by a network entity, comprising: sending, to a user equipment, a signal comprising an OFDM symbol, wherein a first time portion of the OFDM symbol is configured for energy harvesting by the user equipment, and a second time portion of the OFDM symbol is configured for data by the user equipment.

Clause 16: The method of Clause 15, wherein the second time portion comprises a number of frequency portions based on a frequency comb configuration for the OFDM symbol.

Clause 17: The method of Clause 16, wherein a length of the first time portion and a length of the second time portion of the OFDM symbol is based on the frequency comb configuration for the OFDM symbol.

Clause 18: The method of Clause 16, wherein the number of frequency portions is evenly divisible with a number of subcarriers in the OFDM symbol.

Clause 19: The method of Clause 18, wherein the number of subcarriers in the signal is 12.

Clause 20: The method of any one of Clauses 15-19, further comprising: sending, to the user equipment, an indication of an orthogonal cover code to apply to the OFDM symbol.

Clause 21: The method of any one of Clauses 15-20, further comprising: configuring a cyclic prefix between the first time portion and the second time portion of the OFDM signal.

Clause 22: The method of Clause 21, wherein the cyclic prefix comprises a downsampled normal cyclic prefix.

Clause 23: The method of any one of Clauses 15-22, further comprising: sending the first time portion of the OFDM symbol at a higher energy level than the second time portion of the OFDM symbol.

Clause 24: The method of any one of Clauses 15-23, further comprising: configuring a second device to send a second OFDM symbol during at least the first time portion of the OFDM symbol.

Clause 25: The method of any one of Clauses 15-24, further comprising: sending, to the user equipment, a first quasi-collocation indication associated with the first time portion of the OFDM symbol; and sending, to the user equipment, a second quasi-collocation indication associated with the second time portion of the OFDM symbol.

Clause 26: The method of Clause 25, wherein the first quasi-collocation indication and the second quasi-collocation indication are sent via downlink control information.

Clause 27: The method of any one of Clauses 15-26, further comprising: receiving, from the user equipment, an indication of an energy state; and configuring the first time portion of the OFDM symbol based on the indication.

Clause 28: The method of Clause 27, further comprising: configuring a comb setting for the OFDM symbol based on the indication of the energy state.

Clause 29: An apparatus, comprising: a memory comprising executable instructions; and a processor configured to execute the executable instructions and cause the apparatus to perform a method in accordance with any one of Clauses 1-28.

Clause 30: An apparatus, comprising means for performing a method in accordance with any one of Clauses 1-28.

Clause 31: A non-transitory computer-readable medium comprising executable instructions that, when executed by a processor of an apparatus, cause the apparatus to perform a method in accordance with any one of Clauses 1-28.

Clause 32: A computer program product embodied on a computer-readable storage medium comprising code for performing a method in accordance with any one of Clauses 1-28.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication by a user equipment, comprising:
receiving a signal comprising an orthogonal frequency-division multiplexing (OFDM) symbol;
harvesting energy from the signal during a first time portion of the OFDM symbol; and
processing data from the symbol during a second time portion of the OFDM symbol.

2. The method of claim 1, wherein processing data from the symbol comprises decoding data and storing the decoded data in a memory of the user equipment.

3. The method of claim 1, wherein processing data from the symbol comprises backscattering data from the OFDM.

4. The method of claim 1, wherein processing data from the symbol is performed using, at least in part, the energy harvested from the signal.

5. The method of claim 1, wherein the second time portion comprises a number of frequency portions based on a frequency comb configuration for the OFDM symbol.

6. The method of claim 5, wherein a length of the first time portion and a length of the second time portion of the OFDM symbol is based on the frequency comb configuration for the OFDM symbol.

7. The method of claim 5, wherein the number of frequency portions is evenly divisible with a number of subcarriers in the OFDM symbol.

8. The method of claim 7, wherein the number of subcarriers in the signal is 12.

9. The method of claim 1, further comprising:
receiving an indication of an orthogonal cover code to apply to the OFDM symbol from a network entity; and
applying the orthogonal cover code to the OFDM symbol to process data from the OFDM symbol.

10. The method of claim 1, further comprising observing a cyclic prefix between the first time portion and the second time portion of the OFDM symbol.

11. The method of claim 10, wherein the cyclic prefix comprises a downsampled normal cyclic prefix.

12. The method of claim 1 wherein a received energy of the signal is higher during the first time portion of the OFDM symbol than during the second time portion of the OFDM symbol.

13. The method of claim 1, wherein receiving the signal comprising an OFDM symbol comprises receiving at least the first time portion of the OFDM symbol from a plurality of devices.

14. The method of claim 1, further comprising:
receiving, from a network entity, a first quasi-collocation indication associated with the first time portion of the OFDM symbol; and
receiving, from the network entity, a second quasi-collocation indication associated with the second time portion of the OFDM symbol.

15. A user equipment configured for wireless communications, comprising: a memory comprising computer-executable instructions; and a processor configured to execute the computer-executable instructions and cause the user equipment to:
receive a signal comprising an orthogonal frequency-division multiplexing (OFDM) symbol;
harvest energy from the signal during a first time portion of the OFDM symbol; and
process data from the symbol during a second time portion of the OFDM symbol.

16. A method of wireless communication by a network entity, comprising:
sending, to a user equipment, a signal comprising an orthogonal frequency-division multiplexing (OFDM) symbol,
wherein a first time portion of the OFDM symbol is configured for energy harvesting by the user equipment, and
wherein a second time portion of the OFDM symbol is configured for data by the user equipment.

17. The method of claim 16, wherein the second time portion comprises a number of frequency portions based on a frequency comb configuration for the OFDM symbol.

18. The method of claim 17, wherein a length of the first time portion and a length of the second time portion of the OFDM symbol is based on the frequency comb configuration for the OFDM symbol.

19. The method of claim 17, wherein the number of frequency portions is evenly divisible with a number of subcarriers in the OFDM symbol.

20. The method of claim 19, wherein the number of subcarriers in the signal is 12.

21. The method of claim 16, further comprising sending, to the user equipment, an indication of an orthogonal cover code to apply to the OFDM symbol.

22. The method of claim 16, further comprising configuring a cyclic prefix between the first time portion and the second time portion of the OFDM signal.

23. The method of claim 22, wherein the cyclic prefix comprises a downsampled normal cyclic prefix.

24. The method of claim 16, sending the first time portion of the OFDM symbol at a higher energy level than the second time portion of the OFDM symbol.

25. The method of claim 16, further comprising configuring a second device to send a second OFDM symbol during at least the first time portion of the OFDM symbol.

26. The method of claim 16, further comprising:
sending, to the user equipment, a first quasi-collocation indication associated with the first time portion of the OFDM symbol; and
sending, to the user equipment, a second quasi-collocation indication associated with the second time portion of the OFDM symbol.

27. The method of claim 26, wherein the first quasi-collocation indication and the second quasi-collocation indication are sent via downlink control information.

28. The method of claim 16, further comprising:
receiving, from the user equipment, an indication of an energy state; and
configuring the first time portion of the OFDM symbol based on the indication.

29. The method of claim 27, further comprising configuring a comb setting for the OFDM symbol based on the indication of the energy state.

30. A network entity configured for wireless communications, comprising: a memory comprising computer-executable instructions; and a processor configured to execute the computer-executable instructions and cause the network entity to:
send, to a user equipment, a signal comprising an orthogonal frequency-division multiplexing (OFDM) symbol,
wherein a first time portion of the OFDM symbol is configured for energy harvesting by the user equipment, and
wherein a second time portion of the OFDM symbol is configured for data by the user equipment.
